(19) United States
(12) Patent Application Publication
(10) Pub. No.: US 2008/0261170 A1
(43) Pub. Date: Oct. 23, 2008

(54) MEDICAL OR DENTAL HANDHELD ELEMENT WITH ANTI-TWIST PROTECTION

(75) Inventor: Gernot Ploy, Burmoos (AT)

Correspondence Address: KLARQUIST SPARKMAN, LLP, 121 SW SALMON STREET, SUITE 1600, PORTLAND, OR, 97204, US

(73) Assignee: W & H Dentalwerk Burmoos GmbH

(21) Appl. No.: 12/107,705

(22) Filed: Apr. 22, 2008

(30) Foreign Application Priority Data
Apr. 23, 2007 (EP) 07008200.3

(51) Int. Cl. A61C 3/00; F16C 35/00

(52) U.S. Cl. 433/114; 384/549

(57) ABSTRACT

A medical or dental handheld element has a rotatably arranged rotary part, at least one roller bearing for bearing support of the rotatably arranged rotary part, the roller bearing having at least one rotatable roller bearing part that is co-rotational with the rotary part and at least one stationary roller bearing part that is stationary in relation to the rotary part, and an anti-twist device or anti-rotation element provided to restrict the stationary roller bearing part from rotating. The anti-twist device comprises a polygonal, generally arc-shaped, open metallic anti-twist device. A handheld element with this anti-twist device is less sensitive to the effects of sterilization or cleaning processes. Also disclosed is a method for manufacturing such a handheld element.

### CROSS REFERENCE TO RELATED APPLICATION

The present application claims priority from pending European Patent Application No. 07008200.3, filed Apr. 23, 2007, which is incorporated herein by reference.

### BACKGROUND

1. Field

This application relates to a medical, in particular dental, handheld element comprising a rotary part, a roller bearing for support of the rotary part and a twist-lock mechanism for the roller bearing.

2. Description of Prior Art

The document U.S. Pat. No. 4,341,520 describes a handheld element having a rotary part that is rotatably mounted in roller bearings and is designed as an impeller having a tool mount. The roller bearings, in particular the outer bearing raceways of the two roller bearings are prestressed by O-rings made of elastomer in the head part of the handheld element and are secured to prevent twisting or rotation in relation to the head part. This design has long been known and is widely used.

One disadvantage of using elastomer O-rings for prestressing and anti-twist device of roller bearings is their wear with repeated cleaning or sterilization. The O-rings here are exposed to different influencing factors such as pressure fluctuations and temperature fluctuations with temperatures of more than 120° C., often more than 130° C., water vapor or corrosive chemicals such as cleaning agents or disinfectants. Due to these influences, the elastomer O-ring swells up and loses its elasticity, so it can no longer reliably perform its functions.

### SUMMARY

Described below is a medical or dental handheld element that addresses some of the problems of the prior art and has an anti-twist device for the outer bearing raceways of the roller bearings that is less sensitive to the effects of sterilization or cleaning processes.

According to one embodiment, the medical or dental, handheld element comprises a rotary part mounted rotatably and at least one roller bearing, in particular a ball bearing, for bearing support of the rotatably mounted rotary part. The roller bearing is situated on a bearing seat and has at least one roller bearing part that is co-rotational with the rotary part and at least one roller bearing part that is stationary relative to the rotary part. The two roller bearing parts are preferably formed by two bearing raceways or slideways in which multiple roller bearing bodies are guided. The handheld element is provided with an anti-twist device or anti-twist protection for the stationary roller bearing part, the anti-twist device being designed as a polygonal, generally circular or arc-shaped, open metallic anti-twist device.

Surprisingly, such a metallic anti-twist device provides adequate prestress on the roller bearing, reliable prevention of rotation of the stationary roller bearing part relative to the bearing seat and adequate damping of vibration without any noticeable increase in noise emission. Due to the metallic design, e.g., being made of a steel, in particular stainless steel, especially preferably spring steel or a beryllium-copper alloy, the anti-twist device additionally has an essentially unlimited stability with respect to the ambient conditions prevailing during sterilization or cleaning or with respect to the substances used for that purpose.

The term “handheld element” comprises in particular straight handles or handpieces, curved handles or handpieces, which are often referred to as contra-angle handpieces in the dental field, as well as parts of handles. Such parts are formed, for example, by a grip section of a handle, the grip being connectable in particular to various head sections for different tools or to gears for different step-up or step-down gear ratios. The parts of handles may, however, also be designed as intermediate pieces, couplings, adapters or independent sleeve sections.

The rotary part that is rotatably mounted by means of the at least one roller bearing comprises rotary parts designed for complete rotation, i.e., for rotation of 360° or more as well as pivotable or oscillating rotary parts that execute rotation with an angle of rotation of less than 360°. The rotary part has, for example, a shaft or one or more shaft parts, an axle, a spindle, a gear or gear parts, a hollow shaft or preferably a tool receptacle device on the front end of the handheld element to receive a treatment tool, e.g., a rotary drill. In a particularly preferred embodiment, the tool receptacle device comprises a hollow shaft on which a fluid-operated impeller or a driving gearwheel is mounted, and a collet accommodated in the hollow shaft for detachable connection of the treatment tool.

The roller bearings that serve to provide bearing support for the rotary part are designed as axial bearings or as radial bearings. The roller bodies of the roller bearings running in the bearing raceways comprise, for example, balls, rollers, needles, barrels or cones. In one embodiment, the roller bearings or parts thereof are made of metal, in particular steel or ceramic. In another embodiment, individual components have coatings, e.g., coatings with ceramic materials, preferably silicon nitride, zirconium nitride or silicon carbide or a hard carbon layer containing metal. The phrase “hard carbon layer containing metal” is understood to subsume all amorphous carbon layers containing hydrogen and/or metal doping (a-C:H; Me-C:H). Preferred dopants include tantalum, tungsten, titanium, chromium, niobium and alloys of these metals. These carbon layers are preferably produced by physical and chemical vapor deposition on the metal components.

In another embodiment, the roller bearing or parts thereof are provided with lubricants, which are applied at the surface or are accommodated in pores or reservoirs. In one embodiment the roller bearings are accommodated in a cage. In another embodiment, recesses or receptacles for rotationally fixed components of the handheld element are provided on a bearing raceway of the roller bearing, in particular for the anti-twist device, or for fastening or bearing elements which are provided for securing the roller bearing in the handheld element.

The anti-twist device or anti-twist protection is designed as a polygonal, preferably rectangular to decagonal, in particular as an octagonal metal element. The angles formed by the corners are preferably approximately the same size, the angles being designed so that the anti-twist device has a circular shape or an arc shape. The angle formed by the corners is approximately between 30° and 60°. The anti-twist device has two free ends, preferably facing one another, so that the anti-twist device forms an elastic flexible spring ring.

In one embodiment, the handheld element has a bearing seat, wherein the anti-twist device comprises first sections contacting the stationary roller bearing part and comprises second sections contacting the bearing seat and wherein the two sections are arranged in alternation on the anti-twist device. Due to this design, a uniform transfer and distribution of forces to the anti-twist device and to the bearing seat and a uniform load on the anti-twist device are achieved in an advantageous manner.

The bearing seat has one or more side walls or bearing surfaces arranged at an angle to one another and is designed in particular as a protrusion, a recess, a shoulder, preferably a ring shoulder, a recess or a receptacle. It comprises at least one component arranged in a rotationally fixed manner in the handheld element, e.g., at least one part of the outer sleeve of the handheld element, of a wall of a cartridge insertable into the handheld element or of a bearing sleeve.

In one embodiment, the second sections contacting the bearing seat area arranged at a distance from the roller bearing. This yields an elastic flexibility of the anti-twist device and/or increases the elasticity of the anti-twist device, so that vibration of the rotary part during rotation is absorbed or dampened in an advantageous manner.

In one embodiment, the anti-twist device has multiple corners or protrusions, wherein the corners or protrusions form the second sections contacting the bearing seat. This shaping of the anti-twist device allows a particularly secure and tight fixation of the anti-twist device and of the stationary roller bearing part in the handheld element.

In one embodiment, the anti-twist device comprises multiple essentially straight, in particular rod-shaped, segments, wherein these segments form the first sections contacting the stationary roller bearing part. This achieves an extremely simple and inexpensive design of the anti-twist device because the individual segments are arranged at an angle to one another, so that the corners or protrusions forming the second sections contacting the bearing seat are formed at the contact points thereof.

The straight segments are preferably designed so that they conform at least partially to the shape of the roller bearing, such that they sag approximately in the direction of the bearing seat. The straight segments thus come in contact with the roller bearing and/or the stationary roller bearing part not only at a point but also over a larger area, thereby achieving an improved, more reliable fixation of the stationary roller bearing part by the anti-twist device.

The conformity of the segments is determined by their dimensions, in particular by the ratio of the diameter to the length of the segments and the elasticity of the material of which the anti-twist device is made. The diameter of the segments preferably amounts to approximately 0.15-0.4 mm, especially preferably approximately 0.2 mm. The length of the segments is preferably approximately 1.5-3.0 mm, especially preferably approximately 2.1 mm. In another preferred embodiment, the anti-twist device is made of alloyed or unalloyed spring steel, in particular spring steel having the steel number 1.4310. Elements such as silicon, manganese or molybdenum, among others, are used for alloying. In another preferred embodiment, the material of which the anti-twist device is made has an elastic modulus of approximately 185-215 kN/mm² at 20° C., especially preferably approximately 200 N/mm² at 20° C.

In one embodiment, the bearing seat has one or more receptacles, in particular a groove or a ring groove with which the second sections contacting the bearing seat engage. Thus, an especially tight and secure fixation of the anti-twist device and the stationary roller bearing part in the handheld element are achieved in an advantageous manner.

To achieve an additional vibration damping and a reduction of noise emission, in one embodiment the metallic anti-twist device is surrounded by a coating, in particular with a plastic coating, e.g., a PVC layer or an elastomer sheathing.

The method for producing a medical, in particular a dental handheld element, includes the following steps:

providing a handheld element and a rotary part arrangeable rotatably in the handheld element,

providing at least one rolling bearing for bearing support of the rotatably arranged rotary part, wherein the roller bearing has at least one roller bearing part that is co-rotational with the rotary part and at least one roller bearing part that is stationary relative to the rotary part,

providing a polygonal, essentially circular or arc-shaped open metallic anti-twist device for the stationary roller bearing part, and

installing the roller bearing for bearing support of the rotary part in the handheld element with the anti-twist device.

The present invention is explained in greater detail below on the basis of preferred embodiments with reference to the accompanying drawings, in which:

### BRIEF DESCRIPTION OF THE DRAWINGS

FIG. 1 shows a part of a medical handheld element with a rotary part mounted rotatably by means of a roller bearing, wherein the outer bearing raceway of the roller bearing is secured by a polygonal, essentially circular or arc-shaped open metallic anti-twist device in the handheld element.

FIG. 2 shows an embodiment of a polygonal generally circular or arc-shaped open metallic anti-twist device or anti-rotation element.

### DETAILED DESCRIPTION

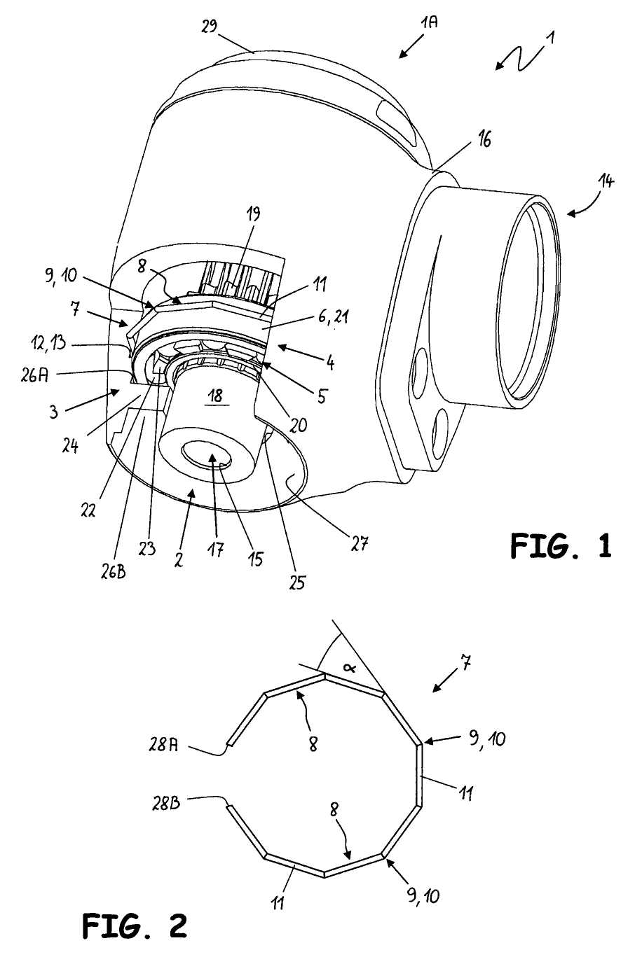

The angle piece head IA shown in FIG. 1 is part of a medical or dental medical handheld element 1. At one end of the angle piece head 1A, a connecting device 14 is provided for connecting another part of the handheld element 1, e.g., a sleeve-shaped neck or grip section. Multiple bores for transferring media, e.g., compressed air or water or for passing through components such as media lines, electric lines or a drive shaft are provided in the connecting device 14. The handheld element 1 is designed as a so-called contra-angle handpiece in which the grip section (not shown) comprises two sections arranged at an angle to one another and in which the tool opening 15 is arranged laterally on the angle head piece 1A, so that a treatment tool can be inserted into the angle piece head 1A across the angle section. A one-piece or multi-piece outer sleeve 16 surrounds the angle piece head 1A. Of course the handheld element may also have other external shapes, e.g., in particular a straight shape or a pistol shape.

The contra-angle handpiece head 1A of the handheld element 1 contains in a known manner a tool receptacle 17 that is accessible via the tool opening 15. The tool receptacle 17 is accommodated at least partially in a hollow shaft 18, which is movably mounted, in particular by means of two roller bearings, only one roller bearing 4 of which can be seen here. The tool receptacle 17 preferably comprises a collet for detachable chucking of a treatment tool, e.g., a rotary drill. A pinion or gearwheel 19 which meshes with another gearwheel is provided on the hollow shaft 18. This additional gearwheel is connected to a drive shaft which transfers a drive motion from a drive unit, e.g., an air motor or an electric motor. As an alternative, a fluid-operated impeller, preferably operated with compressed air, may be secured to the hollow shaft 18 which can be induced to rotate jointly with the hollow shaft 18 and the tool receptacle 17.

On the side of the contra-angle handpiece head 1A opposite the tool opening 15, a tool release mechanism with a pushbutton 29 for removing a tool chucked in the tool receptacle 17 is provided.

Due to the transfer of the driving movement from the drive unit via the drive shaft, the gearwheel 19, the hollow shaft 18 and the tool receptacle 17 are induced to a rotational movement. The components 17, 18 and 19 thus form a rotary part 2 rotatably arranged in the handheld element 1 and accommodated rotatably in the contra-angle handpiece head 1A by the roller bearing 4 and another roller bearing. Since the two roller bearings have the same design, in the remaining description only roller bearing 4 will be specified, but the description may also apply to the other roller bearing.

The roller bearing 4 which is designed as a ball bearing, is arranged in a bearing seat 3. The bearing seat 3 comprises a part of the outer sleeve 16 of the contra-angle handpiece head 1A and a ring shoulder 24 which is designed as a one-piece construction with the outer sleeve 16 and protrudes away from the inside wall of the outer sleeve 16 by an angle of approximately 90°. The ring shoulder 24 is provided with a bore 25 through which a section of the rotary part 2, in particular a part of the hollow shaft 18 and the tool receptacle 17 protrudes. The ring shoulder 24 has two mutually opposing surfaces 26A, 26B, wherein the surface 26A facing the gearwheel 19 serves as a supporting surface for the roller bearing 4. A spring disk for axial prestressing of the roller bearing 4, which has been omitted from FIG. 1 for clarity, is preferably provided between the surface 26A and the roller bearing 4. The surface 26B facing the tool opening 15 together with a tapering section of the outer sleeve 16 forms a receptacle 27 for a media dispensing device, e.g., for a spray plate or for nozzle openings (not shown).

The roller bearing 4 comprises an inner bearing raceway 20, an outer bearing raceway 21 and roller elements arranged between them in the form of balls 22 which are separated from one another by a roller bearing cage 23. The roller bearing 4 is connected to the rotary part 2, e.g., by being pushed or pressed onto it. The inner bearing raceway 20 comes in contact with the rotary part 2 and rotates with the rotary part 2, like the balls 22 and the cage 23, so that the components 20, 22 and 23 form the roller bearing part 5 that is rotatable in relation to the rotary part 2 and in relation to the bearing seat 3. In contrast with that, the outer bearing raceway 21 stands still, so that it forms a stationary roller bearing part 6 in relation to the rotary party 2 and in relation to the bearing seat 3.

To arrange the stationary roller bearing part 6 in a rotationally fixed manner in the bearing seat 3 and in the handheld element 1, an anti-twist device (or anti-rotation element) also referred to as anti-twist protection, is provided. In the illustrated embodiment, an anti-twist device 7 having a ring shape, such as an open ring shape, is shown. The anti-twist device 7 may be arc-shaped, even approaching a circular shape. The anti-twist device can be formed of metal or other suitable materials having sufficient strength, resilience and suitability for the operating environment.

In some embodiments, such as is shown in FIG. 2, the anti-twist device 7 can be described as having a generally polygonal shape comprising a plurality of segments 11, specifically nine straight, in particular rod-shaped, segments in the embodiment according to FIG. 2. The segments 11 can have a round cross section, in particular a circular cross section, the diameter of which amounts to approximately 0.2 mm in the embodiment according to FIG. 2. A single segment 11 of the anti-twist device 7 shown in FIG. 2 is approximately 2.1 mm long, and the distance between two opposing segments 11 is approximately 6.5 mm.

The segments 11 are arranged at an angle to one another, so that one corner 10 each is formed at the contact points between the two segments 11, thus a total of eight corners 10 in the embodiment according to FIG. 2. The angle a between two segments 11 of the anti-twist device 7 shown in FIG. 2 amounts to approximately 36°. The anti-twist device 7 has an essentially circular shape but it has two free ends 28A, 28B between which an opening is provided, so that the anti-twist device 7 is designed as an open spring ring. The distance between the two free ends 28A, 28B of the anti-twist device 7 shown in FIG. 2 amounts to approximately the length of one segment 11, but of course it may also be larger or smaller.

As shown in FIG. 1, a receptacle 12 in the form of a ring groove 13 extending along the entire inside wall of the outer sleeve 16 is provided on the bearing seat 3, so that parts of the anti-twist device 7 engage in this ring groove 13. In particular the corners 10 protrude into the ring groove 13 and form the second sections 9 contacting the bearing seat 3, whereas parts of the segments 11 contact the roller bearing 4 and do not protrude into the ring groove 13 and thus form the first sections 8 of the anti-twist device 7 which contact the roller bearing 4. The anti-twist device 7 surrounds the roller bearing 4 at approximately half the height of the roller bearing 4. Accordingly, the receptacle 12 is a distance of approximately half the height of the roller bearing away from the ring shoulder surface 26A.

The present application is not limited to the embodiments described herein but instead comprises all embodiments that apply or contain the basic principles. Thus, the anti-twist device or anti-twist protection in particular may also have a plurality of individual components, e.g., two or three, each having an arc shape and being joinable or installable in the handheld element in such a way that they yield an essentially circular anti-twist device.

What is claimed is:

1. A medical or dental handheld element comprising a rotatably arranged rotary part, at least one roller bearing for bearing support of the rotatably arranged rotary part, wherein the roller bearing comprises at least one rotatable roller bearing part that is co-rotational with the rotary part and at least one stationary roller bearing part that is stationary in relation to the rotary part, and a polygonal, generally arc-shaped, open, metallic anti-twist device for the stationary roller bearing part.

2. The handheld element according to claim 1,
comprising a bearing seat wherein the anti-twist device has first sections contacting the stationary roller bearing part and second sections contacting the bearing seat.

3. The handheld element according to claim 2, wherein
the first sections contacting the stationary roller bearing part and the second sections contacting the bearing seat are arranged in alternation on the anti-twist device.

4. The handheld element according to claim 2, wherein
the second sections contacting the bearing seat are arranged at a distance from the roller bearing.

5. The handheld element according to claim 2, wherein
the anti-twist device comprises multiple corners or protrusions, wherein the corners or protrusions form the second sections contacting the bearing seat.

6. The handheld element according to claim 2, wherein
the anti-twist device comprises a plurality of essentially straight, in particular rod-shaped segments, wherein these segments form the first sections contacting the stationary roller bearing part.

7. The handheld element according to claim 6, wherein
the straight segments are configured so that they at least partially conform to the roller bearing.

8. The handheld element according to claim 2, wherein
the bearing seat has at least one receptacle configured to be contacted by the second sections, wherein the at least one receptacle comprises a groove or a ring groove.

9. The handheld element according to claim 1, wherein
the anti-twist device is made of a steel.

10. The handheld element according to claim 1, wherein
the anti-twist device is provided with a plastic coating.

11. The handheld element according to claim 1, wherein
the rotary part comprises a tool receptacle for accommodating a treatment tool.

12. The handheld element according to claim 1, wherein
the anti-twist device comprises a plurality of generally straight, rod-shaped segments and corners formed at intersections of adjoining segments, and wherein at least the corners contact the stationary roller being part.

13. The handheld element according to claim 1, wherein
the anti-twist device comprises a plurality of generally straight, rod-shaped segments, wherein each segment has a first end and a second end and the free ends are each formed by one end of a segment.

14. The handheld element according to claim 13, wherein
the segments are arranged at an angle to one another so that the free ends are facing one another.

15. A medical or dental handheld element, comprising
a rotatably arranged rotary part, at least one roller bearing for bearing support of the rotatably arranged rotary part wherein the roller bearing comprises at least one rotatable roller bearing part that is co-rotational with the rotary part and at least one stationary roller bearing part that is stationary in relation to the rotary part, and an anti-rotation element for the stationary roller bearing part comprising an open spring ring formed of a resilient material having two free ends between which an opening is provided.

16. The handheld element according to claim 15, wherein
the anti-rotation element has a generally polygonal-shaped boundary comprising substantially straight, rod-shaped segments that are arranged at an angle to one another.

17. The handheld element according to claim 16, wherein
each of the segments has a first end and a second end, and the free ends are each formed by a respective end of one of the segments adjacent the opening.

18. The handheld element according to claim 15, wherein the anti-rotation element comprises stationary roller bearing part contact areas configured to contact the stationary roller bearing part and bearing seat contact areas configured to contact a bearing seat, and wherein the bearing seat contact areas are generally interspersed with the stationary roller bearing part contact areas.

19. The handheld element according to claim 18, wherein the anti-rotation element comprises multiple segments joined end to end, and wherein the bearing seat contact areas comprise intersections between the segments, and the stationary roller bearing part contact areas comprise portions of the segments.

20. A method for manufacturing a medical or dental handheld element, comprising:
providing a handheld element and a rotary part arrangeable rotatably in the handheld element,
providing at least one roller bearing for bearing support of the rotatably arranged rotary part, wherein the roller bearing comprises at least one rotatable roller bearing part that is co-rotational with the rotary part and at least one stationary roller bearing part that is stationary relative to the rotary part,
providing a polygonal, generally arc-shaped, open metallic anti-twist device for the stationary roller bearing part, and
installing the roller bearing for bearing support of the rotary part in the handheld element with the anti-twist device.
